(19) United States
(12) Patent Application Publication
(10) Pub. No.: US 2016/0209024 A1
(43) Pub. Date: Jul. 21, 2016

(54) CONTAINER FOR STORAGE OF CONTACT LENSES

(71) Applicant: Mark DeWitt Sale, San Diego, CA (US)

(72) Inventor: Mark DeWitt Sale, San Diego, CA (US)

(21) Appl. No.: 14/599,744

(22) Filed: Jan. 19, 2015

(51) Int. Cl. F21V 33/00; A45C 11/00; A45C 13/02; F21L 4/02

(52) U.S. Cl. CPC F21V 33/004; F21V 33/0064; F21L 4/02; A45C 11/005; A45C 13/02; F21W 2131/30

(57) ABSTRACT

A container for transporting contact lenses which in some embodiments may comprise: a container lid having an exterior surface and an interior surface with the interior surface having a mirror; a container base flexibly coupled to the container lid, the container base having an exterior surface and an interior surface, with the interior surface comprising a shelf member; a light source positioned within the container; a power source in electrical communication with the light source; and a left contact lens well and a right contact lens well positioned within the shelf member. In further embodiments, the container may comprise a retractable tray which may optionally be flush mounted within the container. Optionally, the container may comprise a bottle cavity configured to be complementary in shape to the typical shape of small or travel sized bottles of contact lens solutions, allowing a complementarily shaped bottle to be secured within the container.

### FIELD OF THE INVENTION

This patent specification relates to the field of containers configured to store contact lenses. More specifically, this patent specification relates to containers that facilitate the storage of contact lenses and other items.

### BACKGROUND

Containers for the storage of contact lenses are known and widespread. These containers typically have two sealable wells, each of which which may be used to store a contact lens. A user may place a contact lens into a sealable well which may also be used to store a solution specifically formulated to clean and prevent the lenses from drying out. To prevent inadvertently confusing a lens designed for use with one eye with the other, these containers may also comprise different indicators such as indicia, colors, and the like on each sealable well.

While currently available contact lens containers are able to store small amounts of contact solution within each well, they are unable to secure other items which are typically required by the users of the contact lenses as they travel. For this reason, users are often forced to go without or forget one or more contact lens associated items which may contribute to less than ideal eye hygiene. For example, users may not bring extra contact lens solution because the solution container is too large to carry conveniently, or they may forget to bring or even loose a small travel size solution container. Without an adequate supply of contact lens solution the user may be prevented from wearing the contact lenses or they may wear them and risk the chance of developing an eye infection.

Additionally, these users may be forced to forego carrying or forget to carry other items not related to contact lens care in order to carry one or more contact lens associated items as they travel. For example, while a user may remember to bring a small mirror to help apply and remove the contact lenses, they may forget to bring a needed building or vehicle key. Similarly, a user may not have a travel sized contact lens solution and be required to bring a bulk solution container which may be so large as to force the user to forego bringing a change purse.

Even if a contact lens user is able to bring the desired contact lens associated items and other items not related to contact lens care, during the course of their day the user may encounter less than ideal conditions for performing contact lens care and maintenance. For example, a user may encounter an environment that does not have a mirror or in which the mirror may be dirty resulting in the user experiencing difficulty applying or removing their contact lenses. Furthermore, the user may require more light than is available in the environment also resulting in contact lens care and maintenance difficulties.

Therefore, a need exists for novel containers configured to store contact lenses. There also exists a need for novel contact lens storage containers configured for the storage of contact lens associated items. There is a further need for novel contact lens storage containers configured for the storage of other items not related to contact lens care. Finally, there exists a need for novel contact lens storage containers for providing suitable conditions for performing contact lens care and maintenance.

### BRIEF SUMMARY OF THE INVENTION

A container for transporting contact lenses is provided. In some embodiments, the container may comprise: a container lid having an exterior surface and an interior surface with the interior surface having a mirror; a container base flexibly coupled to the container lid, the container base having an exterior surface and an interior surface, with the interior surface comprising a shelf member; a light source positioned within the container; a power source in electrical communication with the light source; and a left contact lens well and a right contact lens well positioned within the shelf member.

In further embodiments, the container may comprise: a container lid having an exterior surface and an interior surface with the interior surface having a mirror and a first light source positioned within the interior surface; a container base flexibly coupled to the container lid, with the container base having an exterior surface and an interior surface, the interior surface comprising a shelf member and a second light source positioned within the shelf member; a power source in electrical communication with the first and second light sources; and a left contact lens well and a right contact lens well positioned within the shelf member.

In still further embodiments, a light source may comprise a LED light source. In even further embodiments, a container may comprise one, two, three, four, five, or more, such as a plurality of light sources.

In still further embodiments, a container may comprise a left contact lens well and right contact lens well which may each be surrounded by a raised perimeter wall and each perimeter wall may have or comprise a thread.

In even further embodiments, a container may comprise a retractable tray which may optionally be flush mounted within the container.

In still further embodiments, the container may comprise a bottle cavity configured to be complementary in shape to the typical shape of small or travel sized bottles of contact lens solutions, eye drops, and the like, allowing a complementarily shaped bottle to be secured within the container.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a front perspective view of an example of a container for transporting contact lenses in an open position according to various embodiments described herein.

FIG. 2 illustrates a top plan view of an example of a container for transporting contact lenses in an open position according to various embodiments described herein.

FIG. 3 shows a top perspective view of an example of a container for transporting contact lenses in a closed position according to various embodiments described herein.

FIG. 4 depicts shows a sectional, through line 4-4 shown in FIG. 2, elevation view of an example of a container for transporting contact lenses in an open position according to various embodiments described herein.

FIG. 5 illustrates a block diagram of some of the elements in electrical communication of an example of a container for transporting contact lenses according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New containers for the storage of contact lenses and other items are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

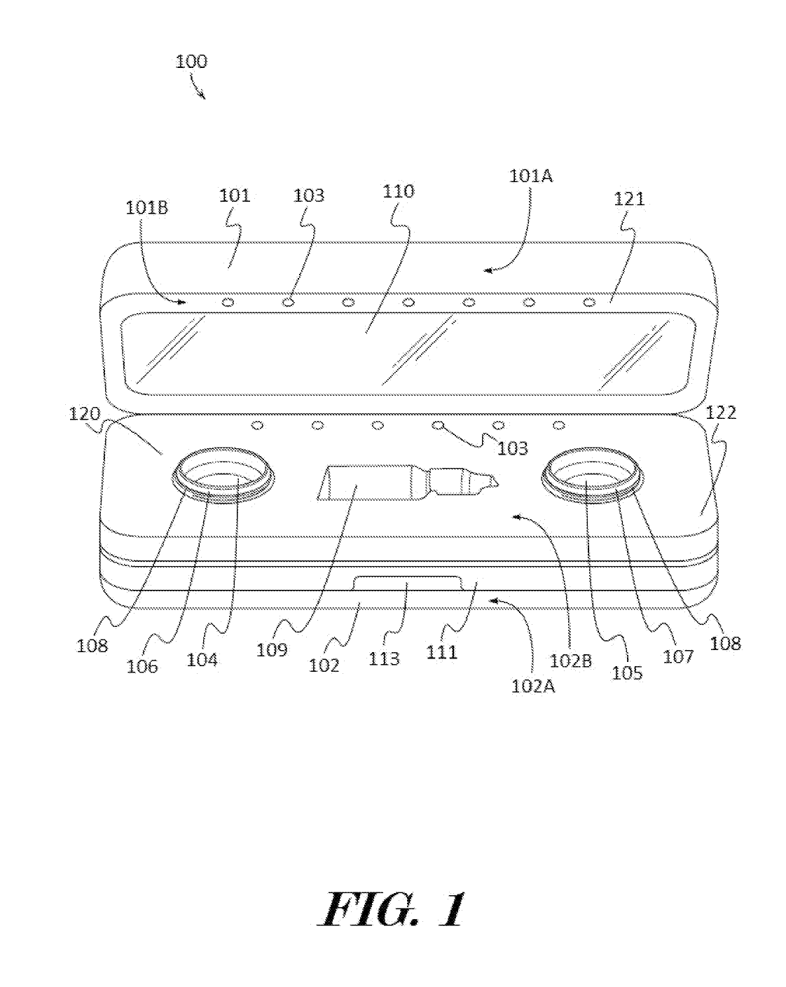

The present invention will now be described by example and through referencing the appended figures representing preferred and alternative embodiments. FIG. 1 illustrates an example of container for storage of contact lenses (“the container”) 100 according to various embodiments. In this example, the apparatus 100 comprises a container lid 101 having an exterior surface 101A and an interior surface 101B with the interior surface 101B having a mirror. The container 100 also comprises a container base 102 flexibly coupled to the container lid 101. The container base 102 may have an exterior surface 102A and an interior surface 102B, and the interior surface 102B may comprise a shelf member 120. A left contact lens well 104 and a right contact lens well 105 may be positioned within the shelf member 120. One or more light sources 103 which may be in electrical communication with a power source 116 may be positioned within the container 100.

A container lid 101 and a container base 102 when aligned and brought together, form a cavity or space between into which elements may be positioned. The container lid 101 and container base 102 may be flexible coupled together allowing portions of the container lid 101 and container base 102 to pivot away from each other while other portions of the container lid 101 and container base 102 remain coupled together. A container base 102 may be flexibly coupled to the container lid 101 with any suitable bendable attachment of the two elements, such as can be achieved by a hinge 117 (FIGS. 1, 2, and 4). A hinge 117 may encompass any type of hinge known in the art, including so-called “living” hinges, which typically comprise a linear, relatively flexible area between two relatively more rigid components, such as a line of thin plastic between thicker plastic portions, as is well known in the art. In other embodiments, a hinge 117 may comprise a butt hinge, barrel hinge, butt/Mortise hinge, case hinge, flag hinge, strap hinge, H hinge, HL hinge, piano hinge, butterfly hinge, flush hinge, barrel hinge, concealed hinge, continuous hinge, T-hinge, strap hinge, double-acting hinge, Soss hinge, counterflap hinge, flush hinge, coach hinge, rising butt hinge, double action spring hinge, tee hinge, friction hinge, security hinge, cranked hinge or stormproof hinge, lift-off hinge, self closing or self positioning hinge, flexible material hinge, or any other type or style of hinge

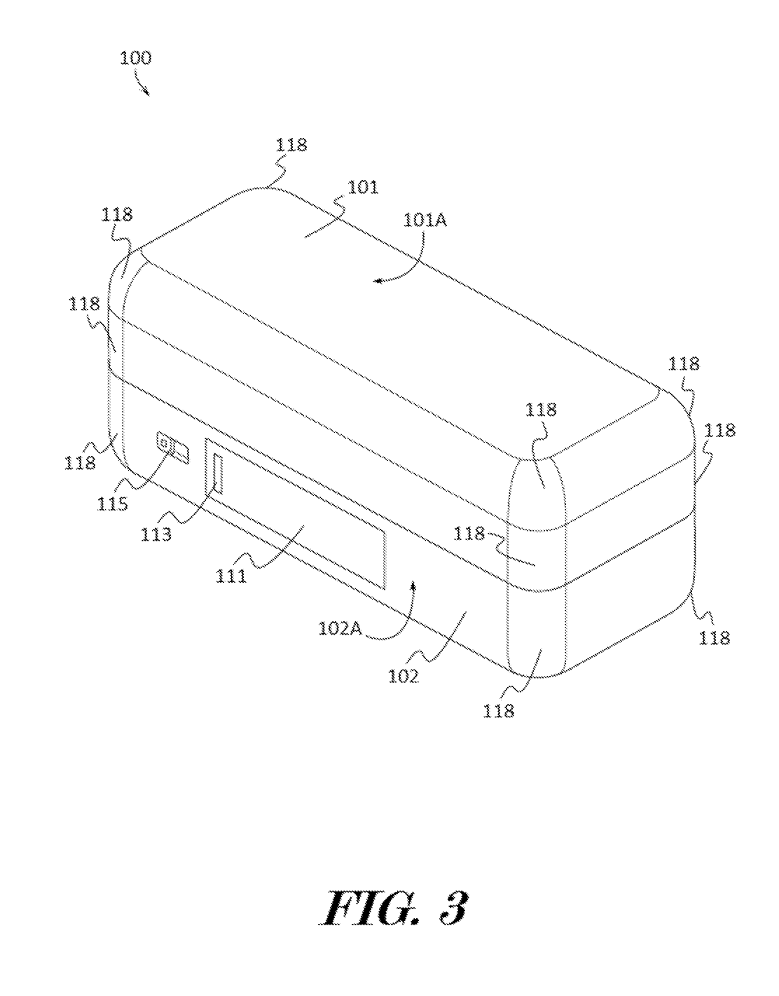

In some embodiments, the lid exterior surface 101A and lid interior surface 101B may be separated by a lid perimeter lip 121. Similarly, the base exterior surface 102A and base interior surface 102B may be separated by a base perimeter lip 122. The container 100 may be movable from an open position, as depicted in FIGS. 1, 2, and 4, to a closed position, as shown in FIG. 3 when the lid perimeter lip 121 and base perimeter lip 122 are brought together. Conversely, the container 100 may be movable from a closed position (FIG. 3) to an open position (FIGS. 1, 2, and 4) when a portion of the lid perimeter lip 121 and a portion of the base perimeter lip 122 are separated thereby granting access to the cavity.

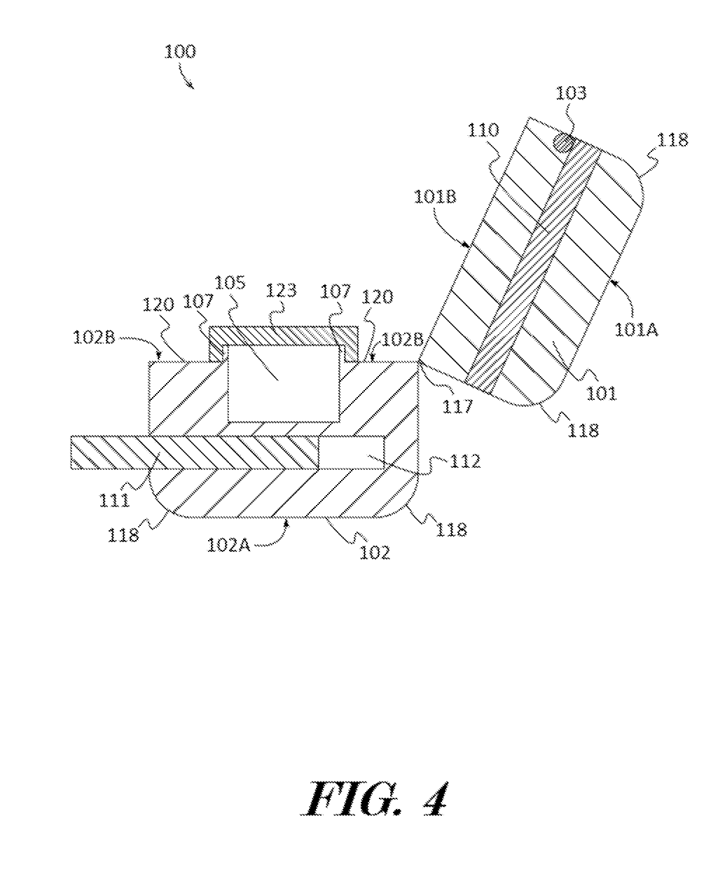

As perhaps best illustrated in FIGS. 3 and 4, in some embodiments, the container lid 101 and container base 102 may be configured with rounded corners 118. In further embodiments, the container lid 101 and container base 102 may be configured with rounded corners 118 so that the container 100 may be configured to form a rectangular shape or rectangular prism shape with rounded corners 118 when moved into a closed position (FIG. 3). In other embodiments, the container lid 101 and container base 102 may be configured with rounded corners 118 and the container 100 may be configured to form a cuboid shape, cylinder shape, triangular prism shape, hexagonal prism shape, or any other geometric or non-geometric shape, including combinations of shapes which may comprise one or more generally rounded corners 118 when moved into a closed position (FIG. 3) and/or an open position (FIGS. 1, 2, and 4).

As shown in FIGS. 1, 2, and 4, in some embodiments, the container may comprise a mirror 110. The mirror 110 may be coupled to the interior surface 101B of the container lid 101 and may comprise a substantially flat or planar mirror, a curved or magnifying mirror, a combination of a planar mirror and a curved mirror, or any other suitably type of mirror. Additionally, a mirror 110 may be mad from any type of reflective material that is suitable for reflecting the reflection of an object such as a user's face and eyes.

In some embodiments, the shelf member 120 (FIGS. 1, 2, and 4) may generally be configured as a planar support coupled to the interior surface 102B of the container base 102 although the shelf member 120 may be configured in other contours besides planar. In further embodiments, the shelf member 120 may be configured to support or position one or more elements of a container 100 such as a left contact lens well 104, a right contact lens well 105, a bottle cavity 109, optionally one or more light sources 103, and/or optionally a battery compartment 114 within the cavity defined by the container lid 101 and the container base 102 when they are aligned and brought together.

The container 100 may comprise one or more contact lens wells such as a left contact lens well 104 (FIGS. 1 and 4) and a right contact lens well 105 (FIGS. 1 and 4) which may be used to store a left contact lens and a right contact lens, respectively. In some embodiments, a left contact lens well 104 and a right contact lens well 105 may each be positioned within the shelf member 120. A left contact lens well 104 and a right contact lens well 105 may each form a depression or cavity within the shelf member 120. In some embodiments, each contact lens well 104, 105, may be surrounded by a raised perimeter wall such as a left perimeter wall 106 which may surround a left contact lens well 104 and a right perimeter wall 107 which may surround a right contact lens well 105. The left perimeter wall 106 may be coupled to the shelf member 120 and be configured to extend above the left contact lens well 104 thereby increasing the volume of the left contact lens well 104. Similarly, the right perimeter wall 107 may be coupled to the shelf member 120 and be configured to extend above the right contact lens well 105 thereby increasing the volume of the right contact lens well 105.

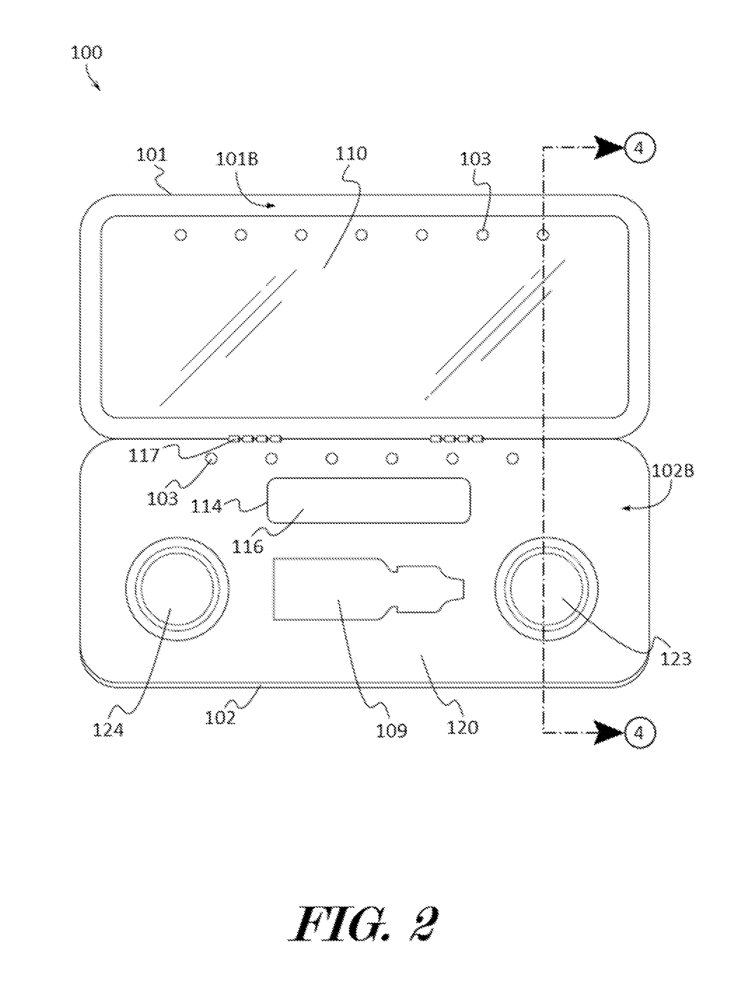

In further embodiments, the left perimeter wall 106 and right perimeter wall 107 may each comprise a thread 108 (FIG. 1) configured to form threading which may be used to secure a left well cover 124 (FIG. 2) and a right well cover 123 (FIGS. 2 and 4), respectively. A left well cover 124 may be configured to be temporarily secured to and seal the left contact lens well 104 to protect a left contact lens and any contact solution that may be contained within the left contact lens well 104, while a right well cover 123 may be configured to be temporarily secured to and seal the right contact lens well 105 to protect a right contact lens and any contact solution that may be contained within the right contact lens well 105. In alternative embodiments, a well cover 123, 124, may be temporarily secured to a lens well 105, 104, by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, a push-to-lock type connection method, a turn-to-lock type connection method, slide-to-lock type connection method or any other suitable temporary connection method as one reasonably skilled in the art could envision to serve the same function.

Turning now to FIGS. 1, 2, 4, and 5, the container 100 may also comprise one or more light sources 103, such as a plurality, which may be positioned within the container 100. In some embodiments, a light source 103 may comprise a light emitting diode (LED) which may be configured to provide light of various wavelengths and intensities. In other embodiments, a light source 103 may comprise an organic light-emitting diode (OLED), incandescent light bulb, halogen light bulb, laser light emitter, electroluminescent light source, neon light source, or any other type of suitable light source. In further embodiments, the container 100 may comprise a plurality of light sources 103 which may be LED light sources 103.

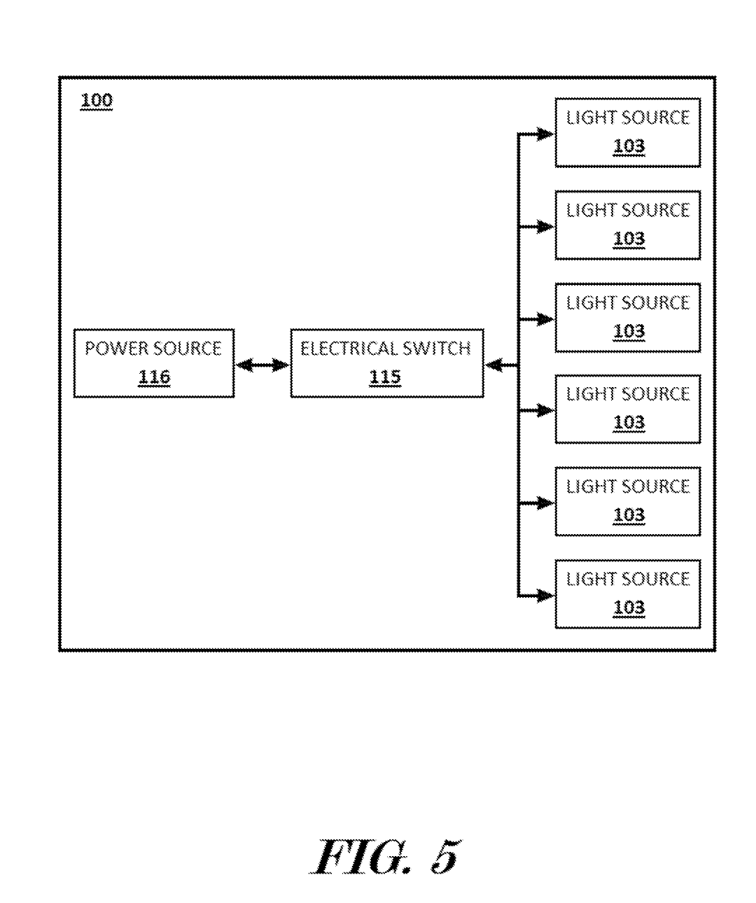

As shown in FIG. 5, the container 100 may also comprise a power source 116 which may be in electrical communication with one or more light sources 103. A light source 103 may be positioned anywhere on the container and be configured to be in electrical communication with a power source 116. In some embodiments, the container lid 101 may comprise a plurality of light sources 103 in electrical communication with the power source 116. In further embodiments, the shelf member 102 may comprise a plurality of light sources 103 in electrical communication with the power source 116. Electrical communication may be provided by a wired connection, a circuit board connection, or any other type of electrical connection capable of communicating electricity between the power source 116 and a light source 103. The electrical communication may be governed by an electrical switch 115. In some embodiments, an electrical switch 115 may comprise a turnable control knob, depressable button type switch, slide type switch, rocker type switch, or any other suitable switch that may be used to modulate the electrical communication between a power source 116 and a light source 103.

In some embodiments, the power source 116 may comprise one or more batteries. In further embodiments, the power source 116 may comprise a primary battery such as an alkaline battery which may be used once and discarded, or a secondary battery such as a lithium ion (Li-ion) battery or a nickel-cadmium (NiCd) battery which may be discharged and recharged multiple times. In still further embodiments, a powers source 116 may comprise any type of electricity storage device such a supercapacitor, fuel cell, UltraBattery, and the like.

Optionally, in some embodiments, a container 100 may comprise a battery compartment 114 which may be used to temporarily secure a replaceable power source 116. In other embodiments, a battery compartment 114 may be used to secure a primary or secondary battery power source 116 which may or may not be removable from the battery compartment 114. In further embodiments, a battery compartment 114 may be used to secure a secondary power source 116 that may be charged by a battery charging element such as a kinetic or motion charging element or by an inductive charging element, wired charging element, or other type of charging element.

Referring now to FIGS. 1, 3, and 4, a container 100 may comprise a retractable tray 111. A retractable tray 111 may be configured to extend out from and retract into portions of the container 100 such as a tray cavity 112 (FIG. 4) positioned within the container base 102. In some embodiments, a retractable tray 111 may be slidably engaged within a tray cavity 112 positioned within the container base 102. Optionally, a retractable tray 111 may comprise one or more depressions which may be configured to receive one or more small items such as keys, money, medication, documents, and the like which may be accesses when the retractable tray 111 is in an extended position (FIG. 4). When a retractable tray 111 is in a retracted position (FIGS. 1-3), items in the retractable tray 111 may be secured with in the container 100 such as in the tray cavity 112. In some embodiments, a retractable tray 111 may comprise a finger pull tab 113 which may be formed by an indention in the retractable tray configured to receive portions of a user's finger to facilitate the extension and retraction of the retractable tray 111. In further embodiments, a retractable tray 111 may be flush mounted within the container base 102 so that when the retractable tray 111 is in a retracted position (FIGS. 1-3), visible portions of the retractable tray 111 may be flush or in the same plane as the portions of the container base exterior surface 102A proximate to the retractable tray 111.

As perhaps best shown in FIGS. 1 and 2, a container 100 may comprise an optional bottle cavity 109. In some embodiments, a shelf member 120 may comprise one or more bottle cavities 109 which may be positioned anywhere on the shelf member 120 such as between the left contact lens well 104 and the right contact lens well 105. A bottle cavity 109 may be configured to be complementary in shape to the typical shape of small or travel sized bottles of contact lens solutions, eye drops, and the like. The bottle cavity may receive a complementarily shaped bottle allowing the bottle to be secured within the container 100 when the container 100 is in a closed position (FIG. 3) and accessed when the container 100 is in an open position (FIGS. 1, 2, and 4).

In further embodiments, a container 100 may comprise a container lid 101 having an exterior surface 101A and an interior surface 101B. The container lid interior surface 101B may comprise a mirror 110 and a first light source 103 positioned anywhere on the container lid interior surface 101B. The container 100 may also comprise a container base 102 which may be flexibly coupled to the container lid 101 such as with a hinge 117, and the container base 102 may comprise an exterior surface 102A and an interior surface 102B. The interior surface 102B of the container base 102 may comprise a shelf member 120. The shelf member 120 may comprise a second light source 103 positioned anywhere within the shelf member 120 and a left contact lens well 104 and a right contact lens well 105 also positioned within the shelf member 120. A power source 116 may be in electrical communication with the first light source 103 and second light sources 103. In further embodiments, the left contact lens well 104 and right contact lens well 105 may each be surrounded by a raised perimeter wall 106, 107, with each perimeter wall 106, 107, having a thread 108. In still further embodiments, the container 100 may further comprise a retractable tray 111 flush mounted within the container 100.

The elements that comprise the container 100 may be made from durable materials such as hard plastics, metal alloys, wood, hard rubbers, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the container 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the container 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the container 100 may be coupled by being one of connected to and integrally formed with another element of the container 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A container for the storage of contact lenses, the container comprising:
a. a container lid having an exterior surface and an interior surface with said interior surface having a mirror;
b. a container base flexibly coupled to the container lid, said container base having an exterior surface and an interior surface, said interior surface comprising a shelf member;
c. a light source positioned within the container;
d. a power source in electrical communication with the light source; and
e. a left contact lens well and a right contact lens well positioned within the shelf member.

2. The container according to claim 1, wherein the container base is flexibly coupled to the container lid with a hinge.

3. The container according to claim 1, wherein the container lid comprises a plurality of light sources in electrical communication with the power source.

4. The container according to claim 3, wherein the plurality of light sources are LED light sources.

5. The container according to claim 1, wherein the container base shelf member comprises a plurality of light sources in electrical communication with the power source.

6. The container according to claim 5, wherein the plurality of light sources are LED light sources.

7. The container according to claim 1, wherein the left contact lens well and right contact lens well are each surrounded by a raised perimeter wall.

8. The container according to claim 7, wherein the raised perimeter wall comprises a thread.

9. The container according to claim 1, wherein the container further comprises a retractable tray.

10. The container according to claim 9, wherein the retractable tray is slidably engaged within a tray cavity positioned within the container base.

11. The container according to claim 9, wherein the retractable tray comprises a finger pull tab.

12. The container according to claim 9, wherein the retractable tray is flush mounted within the container base.

13. The container according to claim 1, further comprising an electrical switch in electrical communication with both the power source and the light source.

14. The container according to claim 1, wherein the container lid and container base have rounded corners.

15. The container according to claim 1, wherein the container forms a rectangular shape with rounded corners in a closed position.

16. The container according to claim 1, wherein the shelf member further comprises a bottle cavity.

17. A container for transporting contact lenses, the container comprising:
a. a container lid having an exterior surface and an interior surface with said interior surface having a mirror;
b. a container base flexibly coupled to the container lid, said container base having an exterior surface and an interior surface, said interior surface comprising a shelf member;
c. a first light source positioned within the container lid interior surface;
d. a second light source positioned within the shelf member;
e. a power source in electrical communication with the first and second light sources; and
f. a left contact lens well and a right contact lens well positioned within the shelf member.

18. The container according to claim 17, wherein the first and second light sources are LEDs.

19. The container according to claim 17, wherein the left contact lens well and right contact lens well are each surrounded by a raised perimeter wall with each perimeter wall having a thread.

20. The container according to claim 17, further comprising a retractable tray flush mounted within the container.
